(19) United States
(12) Patent Application Publication
(10) Pub. No.: US 2025/0136431 A1
(43) Pub. Date: May 1, 2025

(54) A PUMPING SYSTEM WITH AN EQUALIZER TUBE

(71) Applicant: Dover Fueling Solutions UK Limited, EDINBURGH (GB)

(72) Inventor: Martin Dickel, Dassel (DE)

(21) Appl. No.: 18/684,027

(22) PCT Filed: Aug. 11, 2022
(86) PCT No.: PCT/EP2022/072578

§ 371 Date: Feb. 15, 2024

(30) Foreign Application Priority Data
Jun. 19, 2021 (SE) 2151136-5

(51) Int. Cl. B67D 7/70; B67D 7/66; B67D 7/76

(52) U.S. Cl. CPC B67D 7/70; B67D 7/66; B67D 7/763

(57) ABSTRACT

The invention relates to a pumping system (2) for a fuel dispensing unit (1), comprising a first pumping unit (3) configured to suck fuel from a fuel storage tank and comprising a first air separator for circulating a part of the fuel with low rate of gas toward a first fuel supply line (15) and to evacuate a gas-enriched part of the fuel toward a first recovery chamber (18), a second pumping unit (4) configured to suck fuel from the fuel storage tank and comprising a second air separator for circulating a part of the fuel with low rate of gas toward a second fuel supply line (16) and to evacuate a gas-enriched part of the fuel toward a second recovery chamber (19), and a manifold (8) comprising a fuel inlet (34) connected to the fuel storage tank, a first fuel outlet (35) connected to a first supply inlet of the first pumping unit (3), and a second fuel outlet (36) connected to a second supply inlet (38) of the second pumping unit (4). The invention also relates to a fuel dispensing unit (1) for refueling vehicles.

### TECHNICAL FIELD

The invention relates to a pumping system for a fuel dispensing unit. The invention also relates to a fuel dispensing unit for refueling vehicles.

### BACKGROUND ART

Fuel dispensing unit classically comprises one or more pumping units comprising each a pump sucking fuel from an underground fuel tank toward a supply line connected to one or two fuel nozzles intended to deliver fuel to a vehicle.

In today's conventional fuel dispensing units, it is common that an additive is added to the fuel of a pumping unit for various reasons. The additive constitutes a highly inflammable substance and is normally held in a container which is placed in connection to the fuel dispensing unit and is connected thereto.

The additive is classically pumped into the fuel at a pressure side of a fuel pumping unit inside the fuel dispensing unit. The additive itself is pumped by means of a pump driven by a motor.

Safety aspects in and around areas containing fuel dispensing units is today a highly debated field and new technology is constantly developed with the intention to increase the safety within such areas. It is well-known that fuel, such as petrol or diesel, is a highly inflammable substance that must be handled with extreme care. An inherent property of fuel, that increases the risks of its handling, is its high volatility. For the above reasons, safety standards such as the UL standards for safety in North America, the ATEX directive in the EU or the European standard EN 13617 pertaining to petrol filling stations have been created for fuel handling to reduce the thereby induced risks.

The patent application EP3747829 provides a solution to satisfy the requirement of new regulations stating that the additive is no longer allowed to be pressurized in concentrated form due to the risk of explosion.

This patent application discloses that the additive units is connected at the suction side of the pumping unit. The additive is thus sucked and no more pressurized.

However, the sucked additive circulates inside the pumping unit and generates a pollution or contamination inside the pumping unit, the fuel nozzle and the hose connecting the fuel nozzle to the pumping unit. It is a drawback when no additive is requested (pure fuel) for the next delivery. The costumer will receive fuel with some additive. It leads to a loss of additive for the owner of the petrol station and a risk to damage the vehicle motor of the costumer.

In contrary, when a blend of additive is requested after a delivery of pure fuel, a lack of additive occurs due to the volume of fuel present between the nozzle of the fuel dispensing unit and the additive injection point.

In one embodiment, a control valve in the additive conduit could be set to distribute a higher level of additive for the first 5 liters of fuel to compensate for the lack of additive in the fuel present in the circuit when the refueling process is initiated. If the preceding refueling process included additive, no such compensation will be necessary.

However, it leads to a complex process and software and the accuracy of the rate of additive is difficult to control.

### SUMMARY OF THE INVENTION

It is an objective of the present invention to mitigate, alleviate or eliminate one or more of the above-identified deficiencies in the art and disadvantages singly or in any combination and solve at least the above-mentioned problems.

A solution for solving this problem is to use two distinctive pumping units including a first pumping unit configured to deliver only blend of fuel and additive and a second pumping unit configured to deliver only pure fuel.

An inlet of the first pumping unit linked to the fuel tank is connected to an additive dispensing unit.

The suction line of the fuel dispensing unit comprises a manifold connecting the two pumping units to the same underground fuel tank.

The manifold comprises a fuel inlet connected to the fuel storage tank, a first fuel outlet connected to a first supply inlet of the first pumping unit via a first filter device and a second fuel outlet connected to a second supply inlet of the second pumping unit via a second filter device.

Each filter device comprises a filter and a valve allowing fuel to circulate from the fuel tank toward the pumping unit and blocking the fuel flow when the fuel circulates in opposite direction. However, a fall back pressure appears when one of a first pumping unit is stopped after a fuel delivery because the stop is brutal. The issue is more the fuel velocity than the pressure because the fuel flow takes time to stop and comes back through the valve of the filter device of the passive second pumping unit that is not used.

Each pumping unit comprises a degassing device to ensure that the measurement of the volume of fuel delivered to the user in fact corresponds to liquid fuel and not to a mixture of liquid fuel and gas (air and petroleum vapors).

The degassing device classically comprises an air separator, Vortex-type for instance, fed with a mixture of liquid fuel/gas through an input pipe connected to the output of the pump. The air separator is equipped with two fuel evacuation pipes, namely, a lateral pipe for the degassed liquid fuel (fuel with low rate of gas) and an axial pipe for a fraction of gas-enriched fuel.

The part of the fuel with low rate of gas is drawn toward the fuel supply line and the gas-enriched part of the fuel is evacuated toward a recovery chamber of the degassing device.

The recovery chamber is an atmospheric pressure separation vessel connected to the axial pipe of the air separator. The recovery chamber enables to separate gas from the liquid fuel by gravity.

The recovery chamber comprises a gas outlet (air vent) connected to atmosphere to evacuate the gas and a fuel outlet equipped with a valve configured to recirculate the degassed part of the fuel toward the pump.

Thus, in case of fall back pressure, the filter device being located downstream the manifold, it could lead to an overfill of the recovery chamber of the passive second pumping unit. The gas outlet of the recovery is normally closed by a float valve when the recovery chamber is full of fuel. But under pressure, a leak can occur throw the gas outlet when the float valve failed due to too much pressure. It leads to a fuel leak in the fuel dispensing unit.

Furthermore, in some other particular cases, two pumping units can be also associated for high speed purpose. For instance, two pumping units delivering each a maximal flowrate of 80 liter/min can be associated for providing a high-speed pumping system delivering 160 liter/min. It could be used for truck refueling application for instance.

A manifold is also used in the suction line for supplying the two pumping units from the fuel tank.

But it also led this issue of fall back pressure and risk of overfilling of one of the pumping units which is not used.

According to a first aspect of the invention, these and other objects are achieved, in full or at least in part, by a pumping system for a fuel dispensing unit. The pumping system comprises a first pumping unit configured to suck fuel from a fuel storage tank and comprising a first air separator for circulating a part of the fuel with low rate of gas toward a first fuel supply line and to evacuate a gas-enriched part of the fuel toward a first recovery chamber, a second pumping unit configured to suck fuel from the fuel storage tank and comprising a second air separator for circulating a part of the fuel with low rate of gas toward a second fuel supply line and to evacuate a gas-enriched part of the fuel toward a second recovery chamber, and a manifold comprising a fuel inlet connected to the fuel storage tank, a first fuel outlet connected to a first supply inlet of the first pumping unit, and a second fuel outlet connected to a second supply inlet of the second pumping unit. The pumping system comprises an equalizer tube fluidly connecting the first recovery chamber and the second recovery chamber.

If a single pumping unit is used, a fall back pressure can occur in the fuel line after the end of the fuel delivery. The filter device being located downstream the manifold, it could lead to an overfill of the recovery chamber of the passive pumping unit that is not used.

Thus, if the passive pumping unit is beginning to overflow, the fuel can flow through the equalizer tube into the recovery chamber of the active pump, where it can be recirculated into the fuel supply line. Thus, the risk of fuel entering the gas outlet is eliminated.

The first recovery chamber may comprise a first gas outlet configured to evacuate gas from the gas-enriched part of the fuel and a first fuel outlet configured to recirculate a degassed part of the fuel from the first recovery chamber toward the first fuel supply line, the first recovery chamber comprises a first hole receiving a first end of the equalizer tube located between the first gas outlet and the first fuel outlet, the second recovery chamber comprising a second gas outlet configured to evacuate gas from the gas-enriched part of the fuel and a second fuel outlet configured to recirculate a degassed part of the fuel from the second recovery chamber toward the second fuel supply line, the second recovery chamber comprises a second hole receiving a second end of the equalizer tube located between the second gas outlet and the second fuel outlet.

The first pumping unit may comprise a first pump body and a first cover mounted above the first pump body for closing the first recovery chamber, the first hole receiving the first end of the equalizer tube being located on the first cover, the second pumping unit comprising a second pump body and a second cover mounted above the second pump body for closing the second recovery chamber, the second hole receiving the second end of the equalizer tube being located on the second cover.

The first cover may have transversal section with a “L” shape and comprises a first horizontal part supporting a first motor and a first vertical part protruding upwardly from the first horizontal part, the first hole being located at a first bottom position of the first vertical part of the first cover, the second cover having a transversal section with a “L” shape and comprises a second horizontal part supporting a second motor and a second vertical part protruding upwardly from the second horizontal part, the second hole being located at a second bottom position of the second vertical part of the second cover.

The pumping system may comprise an additive dispensing unit connected to the first supply inlet of the first pumping or to the second supply inlet of the second pumping unit enabling the first pumping unit or the second pumping unit to supply a blend of fuel and additive to the first fuel supply line or the second fuel supply line.

The equalizer tube is particularly useful in case of additive application for avoiding overfilling of fuel through the gas outlet (air vent) of the air separator.

The equalizer tube may comprise a first part connected to a second part by means of a coupling.

It enables to facilitate the mounting of the equalizer tube on the two pumping units. The coupling enables the first part to rotates with respect to the second part. The distance between the two pumping units could vary a little from one pumping system to another. The coupling enables thus to adjust the length of the equalizer tube during the mounting.

Thus, the first part can be fixed to the first pumping unit via the first end and the second part can be fixed to the second pumping unit via the second end. The two parts are then connected by means of the coupling.

A first filter device may be provided between the first fuel outlet of the manifold and the first supply inlet of the first pumping unit, and a second filter device is provided between the second fuel outlet of the manifold and the second supply inlet of the second pumping unit, the first filter device or the second filter device comprising a first additive inlet connected to the additive dispensing unit.

It enables to provide a connection of the additive line in the fuel suction line in a simple manner and limiting the use of additional components.

The first additive inlet may be arranged at a bottom section of the first filter device or the second filter device.

The first additive inlet may be arranged between a first filter of the first filter device and the first supply inlet of the first pumping unit or between a second filter of the second filter device and the second supply inlet of the second pumping unit.

The first filter device or the second filter device may be connected to the additive dispensing unit via an injection coupling comprising the first additive inlet.

The injection coupling may comprise a drainage bore intended to drain fuel from the first filter device toward the first pumping unit or from the second filter device toward the second pumping unit.

It enables to use a single component providing several functions (drainage and additive injection).

The drainage bore may comprise an internal thread for screwing a pressure sensor.

The first additive inlet may be connected to a first additive line of the additive dispensing unit, the injection coupling comprising a second additive inlet connected to a second additive line of the additive dispensing unit.

It enables to double the additive flow rate via two similar additive pumping units when two sides of the fuel dispenser are used to deliver fuel and additive blend inside two vehicles in a simple manner.

According to a second aspect of the invention, these and other objects, and/or advantages that will be apparent from the following description of embodiments, are achieved, in full or at least in part, by a fuel dispensing unit for refueling vehicles comprising a pumping system according to the feature described above.

Effects and features of the second aspect of the present invention are largely analogous to those described above in connection with the first aspect of the inventive concept. Embodiments mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

As used herein, the term “comprising”, and variations of that term are not intended to exclude other additives, components, integers, or steps.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals may be used for similar elements, and wherein:

FIG. 1 is a perspective view of one exemplary embodiment of a fuel dispensing unit having a pumping system according to the invention.

FIG. 2 is a schematic view of the fuel dispensing unit in FIG. 1.

FIG. 3 is a perspective view of one exemplary embodiment of the pumping system according to the invention.

FIG. 4 is a cross-section of the pumping system in FIG. 3.

FIG. 5 is a schematic view of parts of the pumping system according to the invention.

### DETAILED DESCRIPTION OF PREFERRED EMBODIMENTS OF THE INVENTION

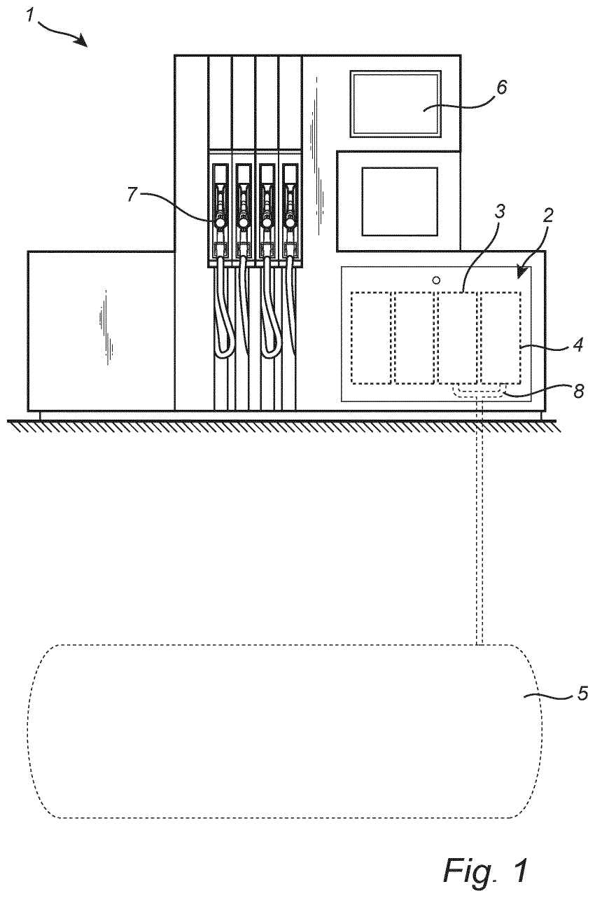

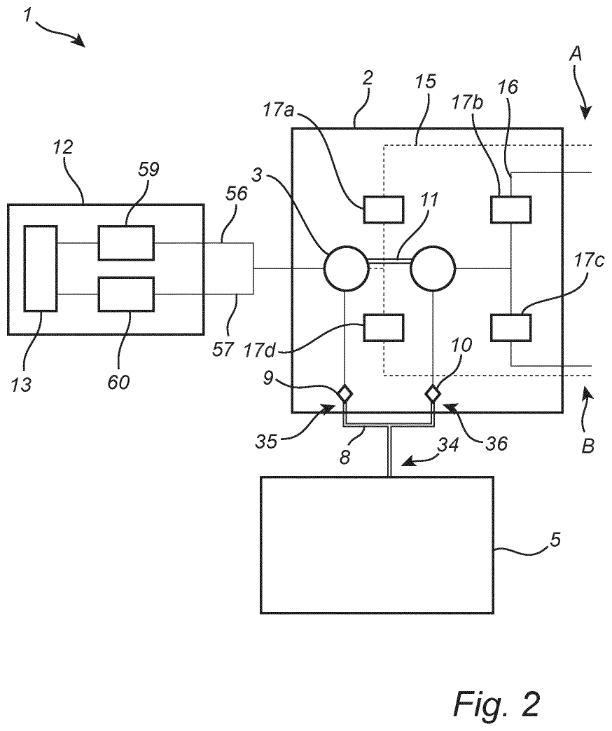

FIG. 1 illustrates an exemplary embodiment of a fuel dispensing unit 1 having a pumping system 2 according to the invention. The pumping system 2 may comprise two or more pumping units 3,4. The two or more pumping units 3,4 may supply fuel to one or more fuel nozzles 7 for filling up a vehicle with fuel. The fuel dispensing system 1 and particularly the pumping system 2 are further described in connection with FIG. 2-5.

The fuel dispensing unit 1 may be fluidly connected to an underground fuel storage tank 5. The fuel storage tank 5 may supply the fuel dispensing unit 1 with fuel. Even though the fuel dispensing unit 1 depicted herein is connected to one fuel storage tank 5, the fuel dispensing unit 1 may be connected to two or more fuel storage tanks. Each tank of the two or more fuel storage tanks may store a different type of fuel, such as petrol, diesel, and biodiesel. In the case of two or more fuel storage tanks, the fuel dispensing unit 1 may comprise two or more pumping systems, one for each fuel storage tank. In addition, two or more fuel dispensing units may be connected to the same fuel storage tank.

The fuel dispensing unit 1 may comprise an input device 6. The input device 6 may for example be a payment terminal as normally found on fuel dispensing units. The input device 6 may comprise a display, as illustrated herein. The input device 6 may allow a customer to choose what fuel type to refuel with, and to pay for the fuel.

The fuel dispensing unit 1 may be two-sided. Put differently, the fuel dispensing unit 1 may comprise a first side and a second side, wherein each side comprises an input device and one or more fuel nozzles. Alternatively, one input device may be used to control both the first and second side of the fuel dispensing unit 1. The first and second side of the fuel dispensing unit 1 allows two vehicles to refuel at the same time, on opposite sides of the fuel dispensing unit 1.

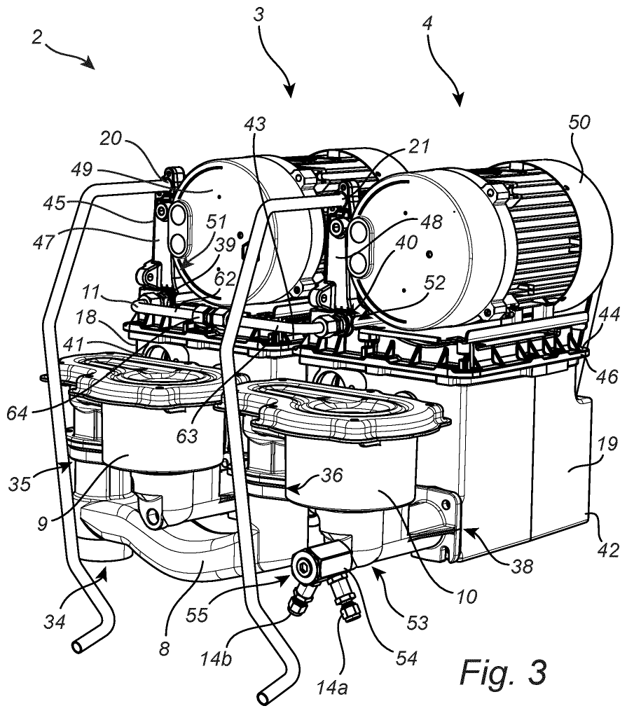

FIG. 2 schematically illustrates the fuel dispensing unit 1. The fuel dispensing unit 1 comprises the pumping system 2 according to the present invention. The pumping system 2 comprises a first pumping unit 3 and a second pumping unit 4. Each pumping unit 3,4 is configured to suck fuel from the fuel storage tank 5. The first pumping unit 3 and the second pumping unit 4 is further described in connection with FIG. 3-5.

The pumping system 2 further comprises a manifold 8. The manifold 8 may comprise a fuel inlet 34 connected to the fuel storage tank 5. The manifold 8 further comprises a first fuel outlet 35, connected to a first supply inlet 37 of the first pumping unit 3. The manifold 8 further comprises a second fuel outlet 36, connected to a second supply inlet 38 of the second pumping unit 4. Put differently, the manifold 8 allows two or more pumping units to connect to the same fuel storage tank 5. The manifold 8 may for example be a T-junction or a Y-junction.

A first filter device 9 may be provided between the first fuel outlet 35 of the manifold 8 and the first supply inlet 37 of the first pumping unit 3.

Correspondingly, a second filter device 10 may be provided between the second fuel outlet 36 of the manifold 8 and the second supply inlet 38 of the second pumping unit 4.

The first filter device 9 comprises a first valve located downstream the first fuel outlet 35 of the manifold 8 and a first filter 27 located downstream the first valve and upstream the first supply inlet 37 of the first pumping unit 3.

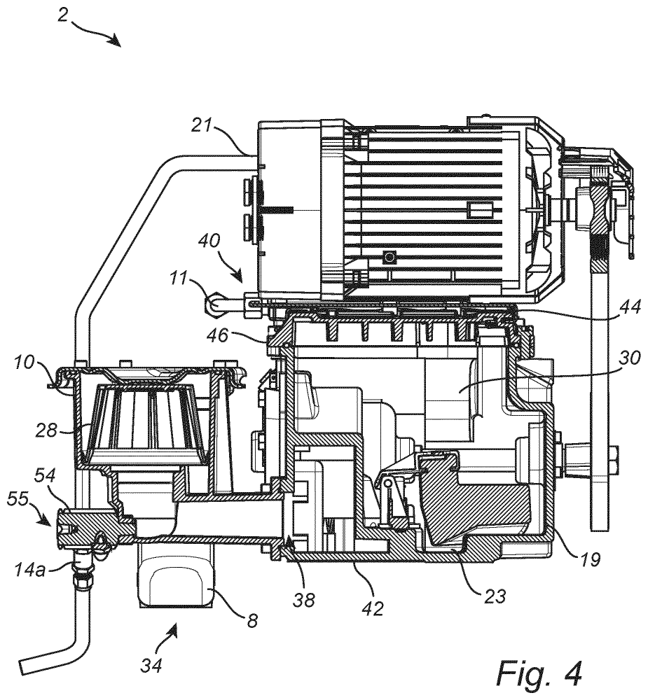

The second filter device 10 comprises a second valve located downstream the second fuel outlet 36 of the manifold 8 and a second filter 28 located downstream the second valve and upstream the second supply inlet 38 of the second pumping unit 4 as illustrated in FIG. 4.

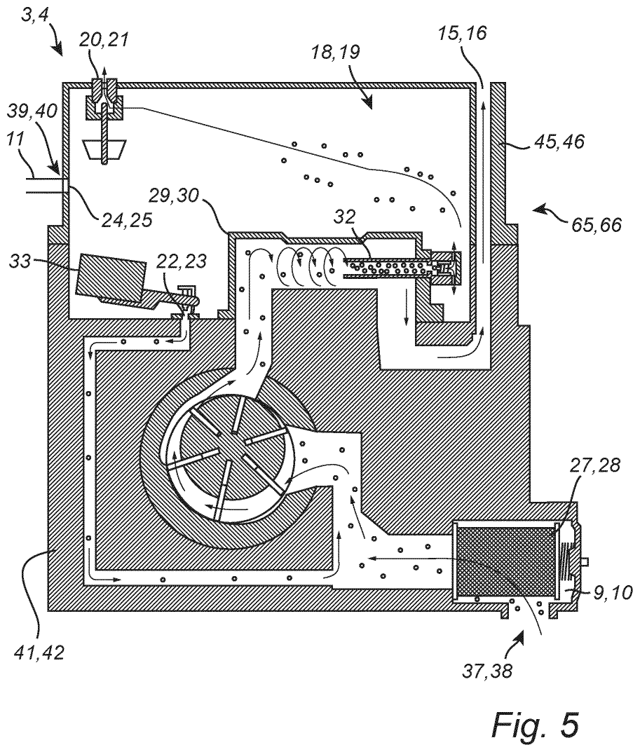

According to a different embodiment in FIG. 5, the filter devices can be embedded in the pumping units.

As illustrated in FIG. 2, the pumping system 2 may further comprise an additive dispensing unit 12. The additive dispensing unit 12 may be connected to the first supply inlet of the first pumping unit 3 or to the second supply inlet of the second pumping unit 4. The additive dispensing unit 12 may enable the first pumping unit 3 or the second pumping unit 4 to supply a blend of fuel and additive to the first fuel supply 15 line or the second fuel supply line 16 respectively. The additive dispensing unit 12 may comprise an additive tank 13, storing the additive. The additive dispensing unit 12 may further comprise one or more additive pumping units, such as a first additive pumping unit 59 connected to a first additive line 56 and a second additive pumping unit 60 connected to a second additive line 57. The additive pumping unit 12 may be configured to pump the additive from the additive tank 13 to the first pumping unit 3 or the second pumping unit 4.

Even though the additive dispensing unit 12 is illustrated as a separate unit from the pumping system 2, it may still be part of the pumping system 2. Similarly, the manifold 8 may be part of the pumping system 2, even though it is illustrated as outside the pumping system 2 in this exemplary embodiment.

In the illustrated example, the additive dispensing unit 12 is connected to the first pumping unit 3 separate from the first filter device 9. It should be noted that this is a non-limiting example. As described above, the additive dispensing unit 12 may be connected to the second pumping unit 4 instead. Alternatively, the additive dispensing unit 12 may be connected to the first or second filter device 9,10.

The first filter device 9 and/or the second filter device 10 may be connected to the additive dispensing unit 12 via an injection coupling 54 comprising the first additive inlet 14a.

The injection coupling may comprise a drainage bore 55 configured to drain fuel from the first filter device 9 toward the first pumping unit 3 or from the second filter device 10 toward the second pumping unit 4. The drainage bore 55 may comprise an internal thread for screwing a pressure sensor.

The first additive inlet 14a may be connected to the first additive line 56 of the additive dispensing unit 12. The injection coupling may comprise a second additive inlet 14b connected to the second additive line 57 of the additive dispensing unit 12.

The pumping system 2 further comprises an equalizer tube 11. The equalizer tube 11 may fluidly connect a first recovery chamber (not shown) of the first pumping unit 3 and a second recovery chamber (not shown) of the second pumping unit 4. The first and second recovery chambers are further described in connection with FIG. 3-5.

The first pumping unit 3 may be connected to one or more fuel nozzles 7 through the first fuel supply line 15. Correspondingly, the second pumping unit 4 may be connected to the one or more fuel nozzles 7 through the second fuel supply line 16. One or more meters 17a-d may be provided at the first and second fuel supply lines 15,16 for measuring the amount of fuel passing through the fuel supply lines 15, 16. The first and second fuel supply lines 15,16 may be split into two outlets respectively, as illustrates herein, for supplying a first A and second side B of the fuel dispensing unit 1.

The first fuel supply line 15 is split into two lines including a first line including a first meter 17a delivering fuel to the first side A of the fuel dispensing unit 1 and a second line including a second meter 17d delivering fuel to the second side B of the fuel dispensing unit 1.

The second fuel supply line 16 is split into two lines including a third line including a third meter 17b delivering fuel to the first side of the fuel dispensing unit 1 and a fourth line including a fourth meter 17c delivering fuel to the second side of the fuel dispensing unit 1.

The additive pumping units 59, 60 are similar and delivers each the same flow rate of additive in the first pumping unit 3. It enables to deliver the same flow rate of additive in the both sides A and B of the fuel dispensing unit 1 when a single side is activated or when the two sides are activated for delivering fuel blend.

Thus, if only side A is activated for delivering fuel into a vehicle, only the first additive pumping unit 59 is activated for delivering a flow rate of additive in fuel. If side A and side B are activated simultaneously for delivering fuel into two vehicles, the first pumping unit 3 will need to deliver a fuel flow that is doubled and split into the first meter 17a and the second meter 17d. The two additive pumping units 59, 60 are thus activated simultaneously for delivering the same flow rate of additive for sides A and B of the fuel dispensing unit 1.

Alternatively, it is possible to use only one additive pumping unit adjusting the additive rate according to the fuel flow requested and doubling the additive rate if the two sides of the fuel dispensing unit 1 are activated for delivering fuel into a vehicle.

Advantage in using two similar additive pumping units 59, 60 is that the accuracy is better with two smaller pumps. The software is also simplest.

Even though not illustrated, the fuel dispensing unit 1 and the pumping system 2 may comprise additional parts as easily realized by a skilled person in the art. For example, valves and fuel lines for controlling the fuel flow through the fuel dispensing unit. These parts have been left out for illustrative purposes.

FIG. 3 is a perspective view of one exemplary embodiment of the pumping system 2 according to the invention. The pumping system 2 comprises the first and second pumping unit 3,4 as described above. The pumping system 2 further comprises the manifold 8 fluidly connecting the first pumping unit 3 and the second pumping unit 4 to the fuel storage tank 5 through the fuel inlet 34 of the manifold 8.

The first pumping unit 3 comprises a first air separator (not shown) for circulating a part of the fuel with low rate of gas toward the first fuel supply line 15. The first air separator is further configured to evacuate a gas-enriched part of the fuel toward the first recovery chamber 18.

The second pumping unit 4 comprises a second air separator (not shown) for circulating a part of the fuel with low rate of gas toward the second fuel supply line 16. The second air separator is further configured to evacuate a gas-enriched part of the fuel toward the second recovery chamber 19.

In the exemplary embodiment illustrated herein, the pumping system 2 comprises the first filter device 9 and the second filter device 10. The first and second filter device 9,10 are provided downstream of the first and second fuel outlet 35, 36 of the manifold 8 and upstream of the first and second supply inlet 37, 38 of the first and second pumping units 3,4.

The second filter device 10 is provided with the first additive inlet 14a and the second additive inlet 14b. Thus, the second pumping unit 4 can be used to refuel a vehicle with a fuel and additive blend, while the first pumping unit 3 can be used to refuel the vehicle with pure fuel. The first additive inlet 14a and the second additive inlet 14b may be arranged at a bottom section 53 of the second filter device 10 as illustrated herein. Alternatively, the first additive inlet 14a and the second additive inlet 14b can be arranged at a bottom section of the first filter device 9.

Preferably, the first additive inlet 14a may be arranged between the first filter 27 of the first filter device 9 and the first supply inlet 37 of the first pumping unit 3 or between a second filter 28 of the second filter device 10 and the second supply inlet 38 of the second pumping unit 4.

The first pumping unit 3 comprises a first recovery chamber 18. The first recovery chamber 18 comprises a first gas outlet 20. The second pumping unit 4 comprises a second recovery chamber 19. The second recovery chamber 19 comprises a second gas outlet 21. The equalizer tube 11 is arranged to fluidly connect the first and second recovery chamber 18,19. Herein the equalizer tube 11 comprises a first end 39 connecting a first hole 24 of the first recovery chamber 18 and a second end 40 connecting a second hole 25 of the second recovery chamber 19. The first hole 24 is located between the first gas outlet 20 and a first fuel outlet 22 of the first recovery chamber 18. The second hole 25 is located between the second gas outlet 21 and a second fuel outlet 23 of the second recovery chamber 19. The first and second recovery chamber 18,19 are further described in connection with FIG. 4.

The equalizer tube 11 has a “U” shape.

The equalizer tube 11 may be a fuel line of any suitable dimension, allowing gas and/or fuel to flow from one recovery chamber to another one. The equalizer tube 11 could be made of steel or polymer. The equalizer tube 11 could be formed of a single part.

Preferably, the equalizer tube 11 comprises a first part 62 connected to a second part 63 via a coupling 64 as illustrated in FIG. 3.

It enables to facilitate the mounting of the equalizer tube 11 on the two pumping units 3, 4. The coupling 64 enables the first part 62 to rotates with respect to the second part 63. The distance between the two pumping units 3, 4 could vary a little from one pumping system 2 to another. The coupling 64 enables thus to adjust the length of the equalizer tube 11 during the mounting.

Thus, the first part 62 can be fixed to the first pumping unit 3 via the first end 39 and the second part 63 can be fixed to the second pumping unit 4 via the second end 40. The two parts 62, 63 are then connected by means of the coupling 64.

If a single pumping unit is used, a fall back pressure can occur in the fuel line after the end of the fuel delivery. The filter device being located downstream the manifold, it could lead to an overfill of the recovery chamber of the passive pumping unit that is not used.

Thus, if the passive pumping unit is beginning to overflow, the fuel can flow through the equalizer tube 11 into the recovery chamber of the active pump, where it can be recirculated into the fuel supply line. Thus, the risk of fuel entering the gas outlet is eliminated.

FIG. 4 is a cross-section of the pumping system 2 illustrated in FIG. 3. In addition to the parts shown in FIG. 3, FIG. 4 also shows an inside of the second recovery chamber 19. The cross-section is shown in the second pumping unit 4. However, it should be noted that what is shown in the second pumping unit 4 also applies for the first pumping unit 3. Thus, the parts of the second pumping unit 4 are below described as part of a general pumping unit.

Each pumping unit 3, 4 comprises a degassing device 65, 66 in order to ensure that the measurement of the volume of fuel delivered to the user in fact corresponds to liquid fuel and not to a mixture of liquid fuel and gas (air and petroleum vapors).

By degassing device 65, 66, it is hereby meant the parts of the pumping unit 3, 4 which have the task of degassing the fuel. For example, the air separator 29, 30 and the recovery chamber 18, 19.

Thus, the first pumping unit 3 comprises a first degassing device 65 comprising a first air separator 29 and the first recovery chamber 18. The second pumping unit 4 comprises a second degassing device 66 comprising a second air separator 30 and the second recovery chamber 19.

The percentage of gas volume allowable in the liquid is defined specifically by regulation R117 of the OIML (International Legal Metrology Organization).

The air separator 29,30, specifically Vortex-type, is fed with a mixture of liquid fuel/gas through an input pipe connected to the output of the pump. The air separator 29,30 is equipped with two fuel evacuation pipes, namely, a lateral pipe 31 for the degassed liquid fuel (fuel with low rate of gas) and an axial pipe 32 for a fraction of gas-enriched fuel.

The air separator 29,30 has an elongated, cylindrical shape, which makes it possible to create, in its interior, a helicoidal circulation of the liquid fuel/gas mixture coming from the pump which makes it possible, on one hand, to collect degassed fuel through the lateral output pipe 31 and, on the other hand, a fraction of gas-enriched mixture through the axial tube 32. This type of degassing system is described, for example, in document EP0357513.

The part of the fuel with low rate of gas is drawn toward the fuel supply line 15,16 and the gas-enriched part of the fuel is evacuated toward the recovery chamber 18,19 of the degassing device.

The recovery chamber 18,19 is an atmospheric pressure separation vessel connected to the axial pipe of the air separator. The recovery chamber 18,19 enables to separate gas from the liquid fuel by gravity.

The recovery chamber 18,19 comprises a gas outlet 20, 21 connected to atmosphere to evacuate the gas and a fuel outlet 22, 23 equipped with a valve 33 configured to recirculate the degassed part of the fuel toward the pump. Thus, the recovery chamber 18,19 can be emptied of fuel when the pumping unit is running.

FIG. 5 is a schematic view of parts of the pumping system 2 according to the invention. More specifically, FIG. 5 is a schematic drawing of a cross-section of either the first or second pumping 3,4 unit to show the flow of the fuel through the pumping unit. The thin arrows without reference numbers illustrates the flow path of the fuel. The small circles around the arrows illustrates gasses, for example air, present in the fuel.

A gas enriched mixture of fuel and air enters from the bottom right of FIG. 5, where it passes through the filter device 9,10. After the filter device 9,10, it is sucked into to the air separator 29,30. In the air separator 29,30, the mixture of fuel and air is circulated to separate the air from the liquid fuel. The degassed fuel is outputted through the lateral output pipe 31 to the fuel supply line 15,16. The air, together with a small amount of fuel is outputted through the axial pipe 32 into the recovery chamber 18,19. The recovery chamber 18,19 comprises a gas outlet 20,21 through which the air can be evacuated. The recovery chamber 18, 19 further comprises a fuel outlet 22,23 through which the fuel in the recovery chamber 18,19 can be evacuated and recirculated back into the air separator 29,30, when the pumping unit 3,4 is running. If instead, the pumping unit is passive, fuel may still enter the recovery chamber 18,19, but without the possibility of being recirculated into the air separator 29,30. Instead, the fuel is able to evacuate from the recovery chamber 18, 19 through the hole 24,25 to which the evacuation tube 11 is connected, when the fuel level reaches to that point. The pumping system 2 may comprise additional parts. For example, different valves for managing the flow of fuel in the pumping unit 2.

The first pumping unit 3 comprises a first pump body 41 and a first cover 45 mounted above the first pump body 41 for closing the first recovery chamber 18. The first hole 24 receiving the first end 39 of the equalizer tube 11 is located on the first cover 45.

The second pumping unit 4 comprises a second pump body 42 and a second cover 46 mounted above the second pump body 42 for closing the second recovery chamber 19. The second hole 25 receiving the second end 40 of the equalizer tube 11 is located on the second cover 46.

The first cover 45 has a transversal section with a “L” shape and comprises a first horizontal part 43 supporting a first motor 49 and a first vertical part 47 protruding upwardly from the first horizontal part 43. The first hole 24 is located at a first bottom position 51 of the first vertical part 47 of the first cover 45. The first horizontal part 43 and the first vertical part 47 are joining near the first hole 24.

The second cover 46 has a transversal section with a “L” shape and comprises a second horizontal part 44 supporting a second motor 50 and a second vertical part 48 protruding upwardly from the second horizontal part 44. The second hole 25 is located at a second bottom position 52 of the second vertical part 48 of the second cover 45. The second horizontal part 44 and the second vertical part 48 are joining near the second hole 25.

This intermediate position of the equalizer tube 11 between the gas outlets 20, 21 and the fuel outlets 22, 23 provides a simplified design and enables the gas enriched part of the fuel to stays in the recovery chambers 18, 19 for the degassing process and not to go through the equalizer tube 11 is case of normal running.

Preferably, the equalizer tube 11 is positioned above the filter devices 9, 10 at a back side of the pumping system 2. The back side of the pumping system 2 corresponds to the side without motor pulley nor motor belt.

It provides a compact arrangement.

It is understood that other variations in the present invention are contemplated and, in some instances, some features of the invention can be employed without a corresponding use of other features. Accordingly, it is appropriate that the appended claims be construed broadly in a manner consistent with the scope of the invention.

1. A pumping system for a fuel dispensing unit, comprising
a first pumping unit configured to suck fuel from a fuel storage tank and comprising a first air separator for circulating a part of the fuel with low rate of gas toward a first fuel supply line and to evacuate a gas-enriched part of the fuel toward a first recovery chamber,
a second pumping unit configured to suck fuel from the fuel storage tank and comprising a second air separator for circulating a part of the fuel with low rate of gas toward a second fuel supply line and to evacuate a gas-enriched part of the fuel toward a second recovery chamber, and
a manifold comprising a fuel inlet connected to the fuel storage tank, a first fuel outlet connected to a first supply inlet of the first pumping unit, and a second fuel outlet connected to a second supply inlet of the second pumping unit,
wherein the pumping system comprises an equalizer tube fluidly connecting the first recovery chamber and the second recovery chamber.

2. The pumping system according to-of claim 1, wherein the first recovery chamber comprises a first gas outlet configured to evacuate gas from the gas-enriched part of the fuel and a first fuel outlet configured to recirculate a degassed part of the fuel from the first recovery chamber toward the first fuel supply line, the first recovery chamber comprises a first hole receiving a first end of the equalizer tube located between the first gas outlet and the first fuel outlet, the second recovery chamber comprising a second gas outlet configured to evacuate gas from the gas-enriched part of the fuel and a second fuel outlet configured to recirculate a degassed part of the fuel from the second recovery chamber toward the second fuel supply line , the second recovery chamber comprises a second hole receiving a second end of the equalizer tube located between the second gas outlet and the second fuel outlet.

3. The pumping system of claim 2, wherein the first pumping unit comprises a first pump body and a first cover mounted above the first pump body for closing the first recovery chamber, the first hole receiving the first end of the equalizer tube being located on the first cover, the second pumping unit comprising a second pump body and a second cover mounted above the second pump body for closing the second recovery chamber, the second hole receiving the second end of the equalizer tube being located on the second cover.

4. The pumping system of claim 3, wherein the first cover has a transversal section with a “L” shape and comprises a first horizontal part supporting a first motor and a first vertical part protruding upwardly from the first horizontal part, the first hole being located at a first bottom position of the first vertical part of the first cover, the second cover having a transversal section with a “L” shape and comprises a second horizontal part supporting a second motor and a second vertical part protruding upwardly from the second horizontal part, the second hole being located at a second bottom position of the second vertical part of the second cover.

5. The pumping system of claim 1, wherein the equalizer tube comprises a first part connected to a second part by means of a coupling.

6. The pumping system of claim 1, wherein it the pumping system comprises an additive dispensing unit connected to the first supply inlet of the first pumping unit or to the second supply inlet of the second pumping unit enabling the first pumping unit or the second pumping unit to supply a blend of fuel and additive to the first fuel supply line or the second fuel supply line.

7. The pumping system of claim 6, wherein a first filter device is provided between the first fuel outlet of the manifold and the first supply inlet of the first pumping unit, and a second filter device is provided between the second fuel outlet of the manifold and the second supply inlet of the second pumping unit, the first filter device or the second filter device comprising a first additive inlet connected to the additive dispensing unit.

8. The pumping system of claim 7, wherein the first additive inlet is arranged at a bottom section of the first filter device or the second filter device.

9. The pumping system of claim 8, wherein the first additive inlet is arranged between a first filter of the first filter device and the first supply inlet of the first pumping unit or between a second filter of the second filter device and the second supply inlet of the second pumping unit.

10. The pumping system of claims 7, wherein the first filter device or the second filter device is connected to the additive dispensing unit via an injection coupling comprising the first additive inlet.

11. The pumping system of claim 10, wherein the injection coupling comprises a drainage bore intended to drain fuel from the first filter device toward the first pumping unit or from the second filter device toward the second pumping unit.

12. The pumping system of claim 11, wherein the drainage bore comprises an internal thread for screwing a pressure sensor.

13. The pumping system of claims 7, wherein the first additive inlet is connected to a first additive line of the additive dispensing unit, the injection coupling comprising a second additive inlet connected to a second additive line of the additive dispensing unit.

14. (canceled)
